(19) United States
(12) Patent Application Publication
(10) Pub. No.: US 2005/0140999 A1
(43) Pub. Date: Jun. 30, 2005

(54) Image recording system, image recorder and printing data processor

(75) Inventors: Hidemi Morii, Kyoto (JP); Keisuke Hirayama, Kyoto (JP); Osamu Shimizu, Kanagawa (JP)

Correspondence Address: MCDERMOTT WILL & EMERY LLP, 600 13TH STREET, N.W., WASHINGTON, DC, 20005-3096, US

(73) Assignees: DAINIPPON SCREEN MFG. CO., LTD.; FUJI PHOTO FILM CO., LTD.

(21) Appl. No.: 11/017,682

(22) Filed: Dec. 22, 2004

(30) Foreign Application Priority Data
Dec. 25, 2003 (JP) JP2003-430008

(51) Int. Cl. G06F 15/00

(52) U.S. Cl. 358/1.9; 358/515

(57) ABSTRACT

An image recording system for setting processing contents related to image recording processing on the basis of the types of color components employed for printing data is provided. A donor sheet roll stored in an image recorder is rendered exchangeable in an intermediate stage of image recording, and recording conditions as to all recordable color components and the storage state of rolls are previously registered in a table. A control part of the image recorder compares/collates information of color components on which color separation data are obtained in a raster image processor with the roll storage state and determines necessariness/unnecessariness of roll exchange, for presenting an exchange object and requesting exchange to an operator if necessary. Thus, a proof image finished approximately to a regularly output image from a regular press can be obtained without increasing the number of rolls stored in the image recorder, so far as inks used in regular press and corresponding rolls are present. An operator is required no skill for operations since he/she may not grasp the roll to be exchanged.

### BACKGROUND OF THE INVENTION

1. Field of the Invention

The present invention relates to an image recording system forming a printed image on the basis of color separation data, and more particularly, it relates to an image recording system mainly forming a printed image for proofreading.

2. Description of the Background Art

In the field of printing, proofing is performed before printing through a printer for mass printing. In proofing, it is desired to output a printed image as close as possible to a finished image in regular press neither at a high cost nor over a long time.

In the field of commercial/industrial design, on the other hand, colors are important design elements for attaining discrimination from others and improving identifiability. Therefore, strict color specification is generally performed for designing the logotype of an enterprise name or a commercial product package or preparing a catalogue or an advertisement therefor. In order to express or reproduce specified colors when printing the logotype, the package, the catalogue or the advertisement, special color inks prepared in response to the specified colors are employed in preference to inks of four colors, i.e., cyan (C), magenta (M), yellow (Y) and black (K) referred to as process colors, for obtaining printed matter exhibiting superior color reproducibility.

In order to perform proofreading as to such printed matter, a mode of obtaining a proof image by expressing the special colors as such is desirable for approximating the finish to regular press. A proofing apparatus capable of expressing the special colors is already known (refer to Japanese Patent Application Laying-Open Gazettes Nos. 11-254773 (1999) and 11-70680 (1999), for example).

Japanese Patent Application Laying-Open Gazette No. 11-254773 discloses an image transferring recorder forming a desired image by transferring color inks from a transfer film (donor sheet) to a receiver sheet by laser exposure. This image transferring recorder is the so-called direct digital color proofer capable of reproducing a halftone image having resolution similar to that formed on actual printed matter every color with a donor sheet of a plurality of colors, more specifically up to six colors at the maximum, for obtaining a proof image finished approximately to regular press.

This image transferring recorder can express the halftone image as such not only with respect to the four process colors but also two additional special colors on the basis of color separation image data of the special colors employed in regular press, so far as a donor sheet capable of expressing the colors can be prepared. If color separation image data for regular press is the one color-separated into a number of colors larger than the upper number of colors (six colors in the above case) simultaneously processible in the image transferring recorder, however, the image transferring recorder cannot reproduce the same as such. In order to obtain a proof image in this case, the image transferring recorder must perform the so-called pseudocolorization of replacing color components of the number of colors exceeding the aforementioned upper limit with color components (those of six colors in the above case) employed in the image transferring recorder. In other words, pseudocolorization is processing of reseparating the color separation data of the color components exceeding the upper limit into color separation data of the color components employed in the image transferring recorder.

If the image transferring recorder performs this pseudocolorization, however, no halftone image of the color components subjected to pseudocolorization is formed but a halftone image of each color component forming the proof image disadvantageously differs from a halftone image originally implemented in regular press due to superposition of information of the color components subjected to pseudocolorization.

Japanese Patent Application Laying-Open Gazette No. 11-70680 discloses a sublimation-type thermal transfer printer capable of performing simulation printing according to color modes responsive to a product image, i.e., proofing. This thermal transfer printer can selectively execute a plurality of printing modes for printing with special colors when a special color printing mode is selected.

When selecting the special color printing mode, the thermal transfer printer first performs printing related to the four process colors, and thereafter performs printing with special colors. However, this thermal transfer printer is not constructed to previously carry ink cartridges of the special colors, and hence an operator must inevitably exchange ink cartridges in a stage of performing printing with the special colors upon completion of printing with the process colors for executing printing in the special color printing mode. In case of printing with a plurality of special colors, further, the operator must determine the special color to be printed and exchange the used ink cartridge every time the thermal transfer printer performs printing as to each special color. This exchange is complicated, and the operator may make a false determination.

### SUMMARY OF THE INVENTION

The present invention relates to an image recording system forming a printed image on the basis of color separation data, i.e., an image recording system mainly forming a printed image for proofreading, and more particularly, it relates to execution of multicolor printing in an image recording system.

According to the present invention, the image recording system comprises a) a printing data processor comprising a-1) a color separation data generation element generating a plurality of color separation data by separating printing layout data into a plurality of color components, a-2) a screening element performing screening processing of generating a plurality of halftone image data outputtable in a prescribed output unit in correspondence to the plurality of color components on the basis of the plurality of color separation data, a-3) a first control element controlling operations of the printing data processor and a-4) a color component information generation element generating color component information indicating the color components on which the color separation data is generated; and b) an image recorder comprising b-1) a transfer film storage element storing a plurality of transfer films corresponding to the plurality of color components, b-2) an image recording element performing multicolor image recording processing of successively transferring inks from each of objective transfer films to a receiver sheet by applying an optical beam to superposed objective transfer film on the receiver sheet thereby superpositively visualizing the plurality of halftone image data on the receiver sheet with different color components, wherein the each of objective transfer films is corresponding to each of the plurality of halftone image data among the plurality of transfer films, b-3) a second control element controlling operations of the image recorder, b-4) a first reference information registration element registering first reference information indicating the types of transfer films usable in the image recorder and b-5) a second reference information registration element registering second reference information indicating the types of the plurality of transfer films stored in the transfer film storage element, while either the first control element or the second control element performs comparison processing of comparing description contents of the color component information with at least single registration contents of the first reference information and the second reference information for setting processing necessary for the multicolor image recording processing on the basis of a result of the comparison processing.

Thus, an operator may not grasp the contents of image recording performed in the image recorder in advance of the image recording also when he/she must perform operations varying with the contents of the printing layout data or the preparatory situation in the image recorder, whereby no skill is required for the operations.

Preferably, the image recorder of the inventive image recording system further comprises b-6) a display element making display for requesting a prescribed operation to an operator, while the image recorder is controlled to be capable of exchanging the transfer films stored in the transfer film storage element with other transfer films not stored in the transfer film storage element in an intermediate stage of the multicolor image recording processing, and the display element displays a prescribed exchange instruction if the plurality of transfer films in the transfer film storage element are inconsistent with a set of transfer films necessary for the multicolor image recording processing as a result of the comparison processing.

Thus, it is implemented that the image recorder performs image recording as to color components exceeding the number of the transfer films simultaneously storable in the transfer film storage element, whereby the number of color components for color separation is unlimited. Further, neither the size of the transfer film storage element nor the size of the overall image recorder is increased.

Alternatively, the printing data processor of the inventive image recording system preferably further comprises a-5) a pseudocolorization element performing pseudocolorization processing of replacing the color separation data as to an arbitrary color component included in the plurality of color separation data with color separation data as to another color component, wherein the another color component is at least one color component corresponding to any transfer film already registered in the first reference information among the plurality of transfer films, the pseudocolorization processing is performed on color separation data as to a color component determined as a transfer film of a type unregistered in the first reference information as the result of the comparison processing in the first control element, and the screening element performs the screening processing on color separation data present after the pseudocolorization.

Thus, the operator may not determine necessariness/unnecessariness of pseudocolorization, whereby he/she can perform the operations also when he/she has no knowledge as to color separation.

Accordingly, an object of the present invention is to provide an image recording system setting processing contents related to image recording processing on the basis of the types of color components employed for printing data.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram schematically showing the structure of an image recording system according to each of first and second embodiments of the present invention;

FIG. 2 is a longitudinal sectional view schematically showing the mechanical structure of an image transferring recorder;

FIG. 3 illustrates an exposure condition set table;

FIGS. 4A to 4C illustrate a rotary rack management table;

FIG. 5 illustrates a color table;

FIG. 6 is a sectional view showing the details of a receiver sheet supply part and a donor sheet supply part;

FIG. 7 is a perspective view partially showing a donor sheet delivery mechanism;

FIG. 8 is a perspective view showing a drum;

FIG. 9 is an enlarged view showing a receiver sheet and a donor sheet wound on the drum;

FIG. 10 illustrates the forward ends of the receiver sheet and the donor sheet completely wound on the drum and a peeler moved down to a peeling position;

FIG. 11 illustrates the forward end of the donor sheet in a state being peeled;

FIG. 12 is a flow chart of image recording processing according to the first embodiment;

FIG. 13 illustrates a flow of data related to image recording;

FIG. 14 is a flow chart of processing in image transferring recording; and

FIG. 15 is a flow chart of image recording processing according to the second embodiment.

### DESCRIPTION OF THE PREFERRED EMBODIMENTS

### First Embodiment

<Image Recording System>

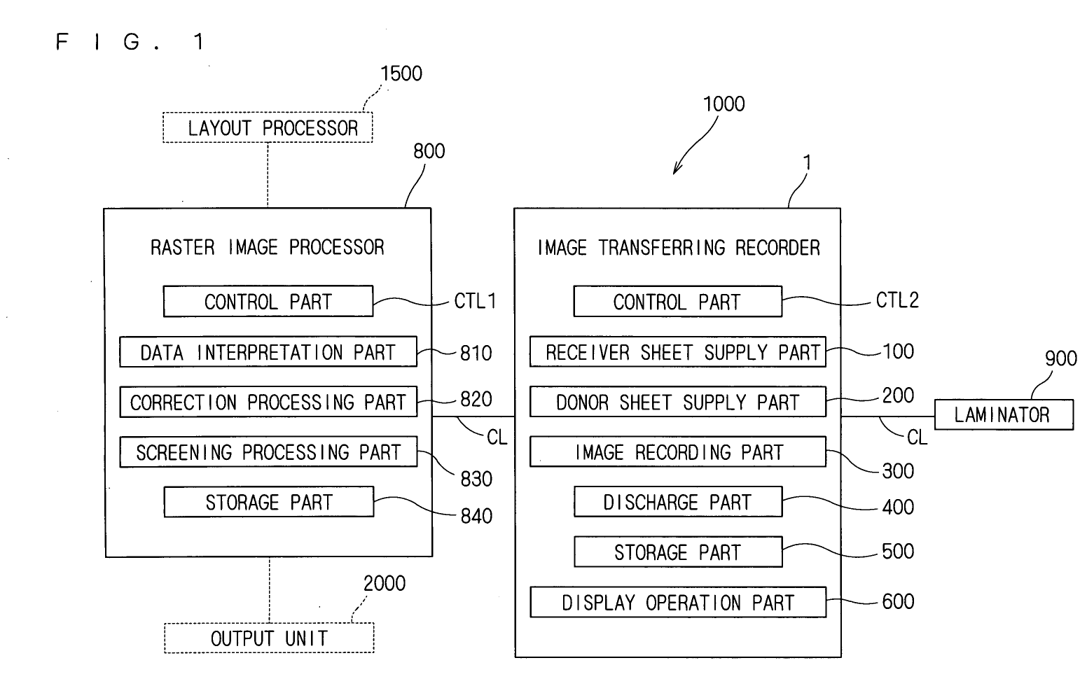

FIG. 1 is a block diagram schematically showing the structure of an image recording system 1000 according to a first embodiment of the present invention. The image recording system 1000 mainly comprises an image transferring recorder 1, a raster image processor 800 and a laminator 900. Communication lines CL connect the image transferring recorder 1 with the raster image processor 800 and the laminator 900 respectively.

The raster image processor 800 reads layout data describing layout information on characters and images to be expressed in printed matter from a layout processor 1500 creating the layout data directly or temporarily through a recording medium. The layout data is preferably described in a prescribed page description language (PDL) such as PostScript (registered trademark by Adobe Systems). The raster image processor 800 is a printing data processor, which is color-separating the read layout data for creating raster data (color separation data) as to a plurality of color components and further performing screening processing (halftone image processing) on the raster data as to the respective color components for generating halftone image data as to the respective color components. The one generated halftone image data is for regular output, supplied to a prescribed output unit 2000 such as an image setter, a CTP or a digital printer for prepress processing or regular press (formation of final printed matter), and the other is for proofing using the image transferring recorder 1.

The image transferring recorder 1 transfers color inks of color transfer films (donor sheets) to a receiver sheet by laser exposure thereby forming a desired image on the receiver sheet. This image transferring recorder 1 is the so-called direct digital color proofer capable of reproducing a halftone image having resolution similar to that formed on actual printed matter every color, with donor sheets of a plurality of colors corresponding to halftone image data output from the raster image processor 800, thereby obtaining a proof image finished approximately to regular press.

The laminator 900 heats/pressurizes the receiver sheet to which the image is transferred in the image transferring recorder 1 and an arbitrary printing paper (regular paper) to be printed thereby transferring the image formed on the receiver sheet to the printing paper.

In other words, the image recording system 1000 according to the first embodiment is a system capable of obtaining a proof image finished equivalently to final printed matter in the image transferring recorder 1.

<Raster Image Processor>

The raster image processor 800 is now described. The so-called general-purpose personal computer reads and runs a prescribed program for implementing the raster image processor 800 through the function of a CPU, a ROM or a RAM of the personal computer. The raster image processor 800 mainly comprises a control part CTL1, a data interpretation part 810, a correction processing part 820, a screening processing part 830 and a storage part 840.

The control part CTL1 controls operations of the respective parts of the raster image processor 800, data transfer between the raster image processor 800 and external devices and the like. As described below, the control part CTL1 also performs to determine whether or not the image transferring recorder 1 is capable of image recording as to color components obtained by color separation as well as to determine necessariness/unnecessariness of pseudocolorization as to a certain color component, by referring to the description of a color table TBL3.

The data interpretation part 810 interprets the description contents of the layout data described in a prescribed format, preferably in a prescribed PDL for generating raster data (color separation data) every color component employed in regular press while generating information (color component information) for specifying each color component. The color component information is referred at the time of deciding processing to be performed on the image transferring recorder 1, as described later. More specifically, specific color codes are previously set for all color components employed in regular press, and the layout data has descriptions about color information with color codes for specifying the color of every object such as a character, a linework or an image in the layout data. The colors of the objects were assigned when the objects were laid out. The data interpretation part 810 generates the raster data (color separation data) by separating the layout data into a plurality of color components on the basis of the color information described in the layout data. At the same time, the data interpretation part 810 generates color component information specifying the color components subjected to generation of the color separation data. In other words, the color component information also indicates as to which color components color separation has been performed.

The correction processing part 820 performs correction such as the so-called color matching and other correction processing on the color separation data. The former is necessary for reproducing the colors expressed in the layout data with fidelity respectively at the regular output on the output unit 2000 and the formation of the proof image on the image transferring recorder 1. In other words, the correction processing part 820 obtains color separation data for the respective apparatuses. As to the color separation data to be supplied to the image transferring recorder 1, the correction processing part 820 also performs pseudocolorization processing for replacing some color components with other color components in advance of color matching, if necessary.

The screening processing part 830 performs screening processing (halftone image processing) generating halftone image data on the basis of properly corrected color separation data. In other words, screening processing is processing of generating halftone image data expressing binary images having high resolution of about 2400 dpi to 4000 dpi from color separation data having multilevel gradation. The screening processing part 830 individually performs this screening processing on the color separation data for the output unit 2000 and the color separation data for the image transferring recorder 1 respectively. The screening processing part 830 supplies halftone image data obtained from the former processing to the output unit 2000 for regular output. Further, the screening processing part 830 supplies halftone image data obtained from the latter processing to the image transferring recorder 1 for formation of the proof image.

The storage part 840 stores the read layout data, the generated color separation data, and halftone image data etc. as well as the color table TBL3 describing information as to color components allowing image formation in the image transferring recorder 1, more specifically, information as to color types of donor sheet rolls (described later) prepared for image recording in the image transferring recorder 1. The color table TBL3 is described later.

<Overall Structure of Image Transferring Recorder>

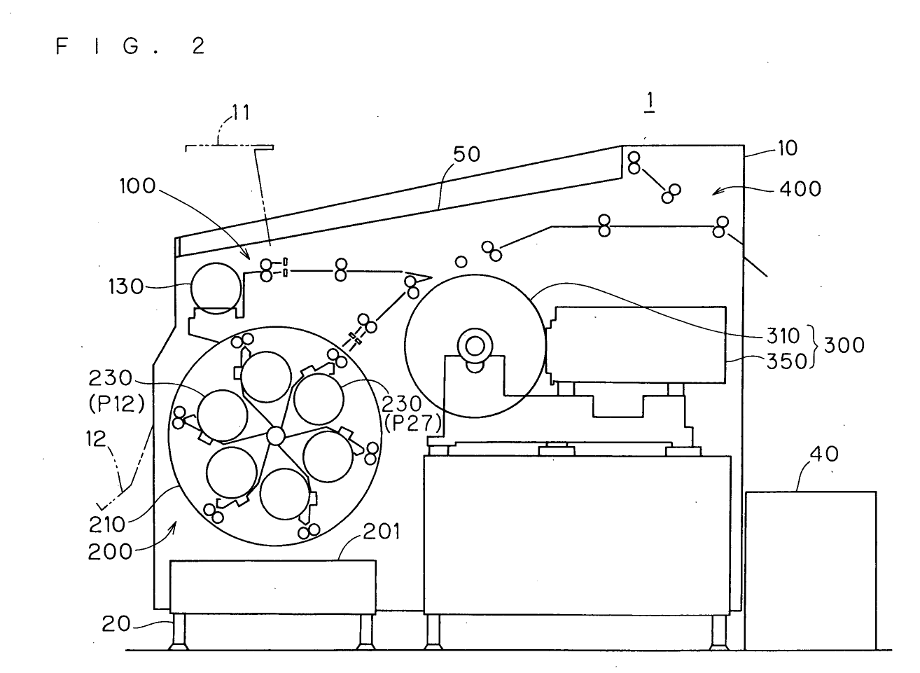

The image transferring recorder 1 is now described. As shown in FIG. 1, the image transferring recorder 1 mainly comprises a receiver sheet supply part 100, a donor sheet supply part 200, an image recording part 300, a discharge part 400, a storage part 500 and a display operation part 600. FIG. 2 is a longitudinal sectional view schematically showing the mechanical structure of the image transferring recorder 1. A cover 10 covers the surface of the image transferring recorder 1. Leg parts 20 support the image transferring recorder 1.

The control part CTL2 controls operations of the respective parts of the image transferring recorder 1, data transfer between the image transferring recorder 1 and external devices etc. More specifically, the control part CTL2 selects a donor sheet roll to be used, determines necessariness/unnecessariness of exchange of any donor sheet roll following this selection and controls the image transferring recorder 1 according to the contents of this determination.

The receiver sheet supply part 100 supplies a receiver sheet to the image recording part 300. The donor sheet supply part 200, capable of supplying a plurality of types of donor sheets, can selectively supply a donor sheet to the image recording part 300 from among the plurality of types of donor sheets. On the image recording part 300, the receiver sheet is wound on a drum 310 and the donor sheet is further wound on it. A laser beam is emitted from a recording head 350 toward the donor sheet superposed on the receiver sheet on the basis of halftone image data received from the raster image processor 800, thereby exposing the receiver sheet. Formation of an image on the receiver sheet is implemented by adhesion and transfer onto it of sublimated and/or melted donors from a portion of the donor sheet heated through the laser exposure. Formation of a multicolor image is implemented by adhering the donors of the donor sheet to the precisely same receiver sheet every color component on the basis of halftone image data as to a plurality of different colors (yellow, magenta, cyan and black, for example). This is attained by successively exchanging donor sheets of the respective colors and laser-exposing the same, while keeping the receiver sheet wound on the drum 310.

The image-formed receiver sheet is discharged through the discharge part 400 and taken from the image transferring recorder 1. The separately provided laminator 900 heats/pressurizes the receiver sheet on an arbitrary printing paper to be printed. Thus, the donors are transferred to the printing paper, thereby forming an image.

The storage part 500 stores the halftone image data received from the raster image processor 800 as well as an exposure condition setting table TBL1 describing exposure conditions for donor sheet rolls (described later) for a plurality of color components prepared for image recording and a rotary rack management table TBL2 indicating a storage situation of the donor sheet rolls in a rotary rack 210 (described later) storing the donor sheet rolls subjected to exposure.

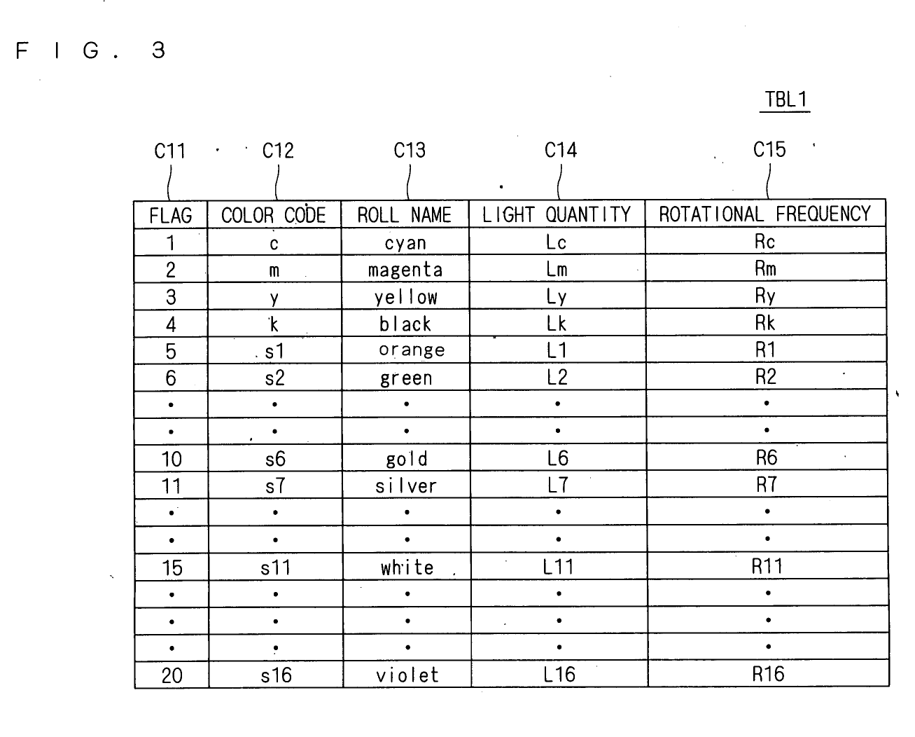

FIG. 3 illustrates the exposure condition setting the table TBL1. The exposure condition setting table TBL1 shown in FIG. 3 associates flags C11 showing identification numbers for identifying the color components, color codes C12 indicating the respective color components, roll names C13 of the donor sheet rolls corresponding to the respective color components, light quantities C14 of the laser beam emitted from the recording head 350 for performing exposure with the donor sheet rolls and rotational frequencies C15 of the drum 310 for registering exposure conditions for the respective color components in the image transferring recorder 1. Those identical to the colors specified in the layout data are employed for the color codes C12. In the exposure condition setting table TBL1 shown in FIG. 3, the process colors are registered among 1 to 4 of flags C11 and the special colors among 5 to 20, respectively. In this case, it follows that the image transferring recorder 1 according to the first embodiment is capable of image recording as to 20 color components at the maximum. The number of the color components is not restricted to this. In case donor sheet rolls for a larger number of special colors are prepared, the image transferring recorder 1 can use a larger number of color components for image recording as long as the color components are registered in the exposure condition setting table TBL 1.

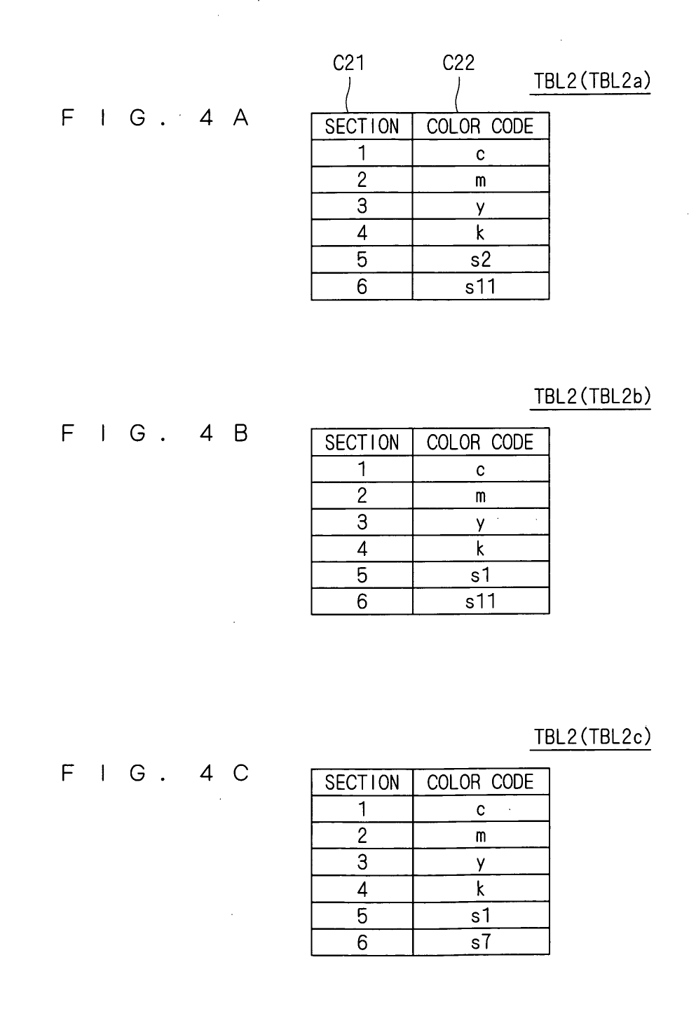

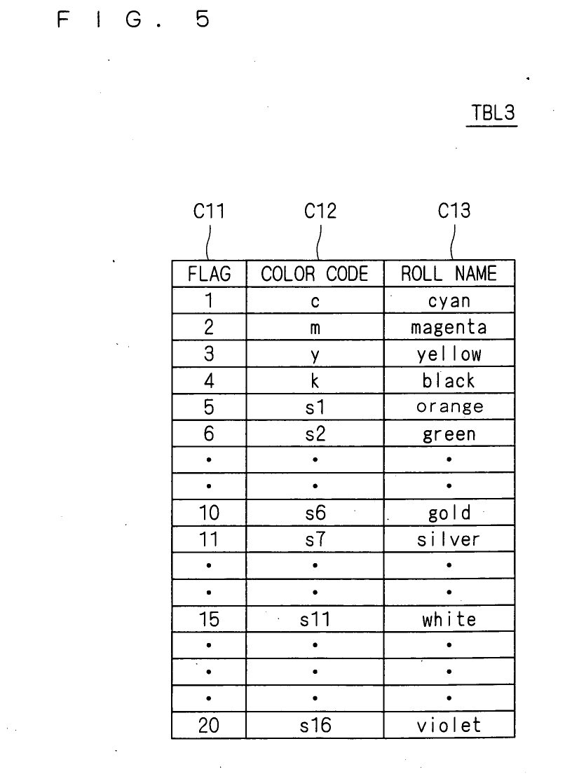

FIGS. 4A to 4C illustrate the rotary rack management table TBL2 (TBL2a to TBL2c). The rotary rack management table TBL2 shown in FIGS. 4A to 4C associates section numbers C21 showing identification numbers for identifying the storage positions of the donor sheet rolls in the rotary rack 210 with color codes C22 showing the color components of the donor sheet rolls stored in the storage positions respectively.

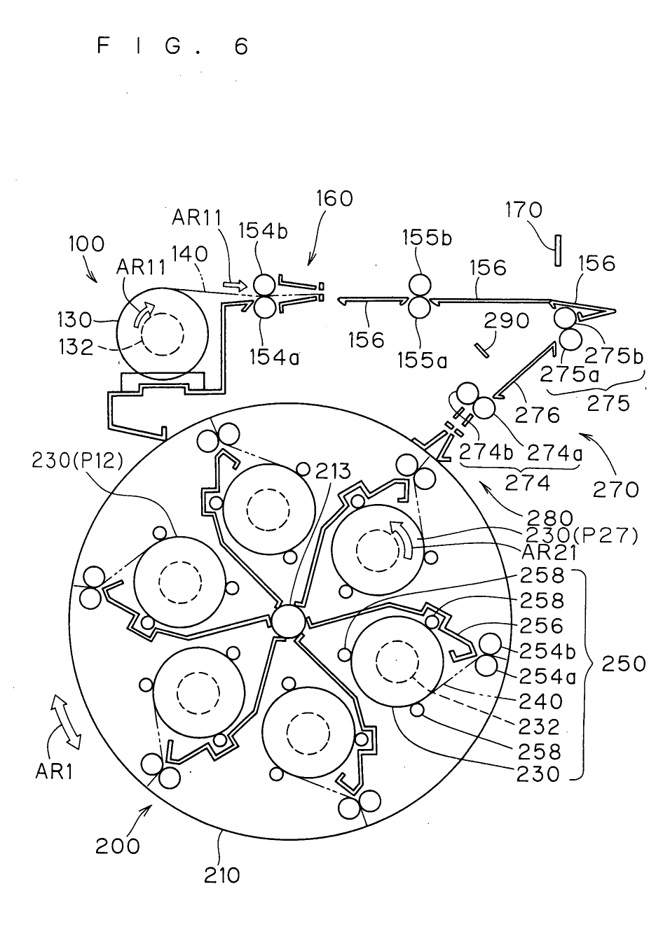

According to the first embodiment, the storage part 840 of the raster image processor 800 stores contents identical to parts of the contents of the exposure condition setting table TBL1 as the color table TBL3. FIG. 5 illustrates the color table TBL3. The color table TBL3 shown in FIG. 5 describes the flags C11, the color codes C12 and the roll names C13 among the description contents of the exposure condition setting table TBL1.

As to data entry in the color table TBL3, an operator may input the same contents as those described in the exposure condition setting table TBL1 punctatim, or the control part CTL1 of the raster image processor 800 may extract the contents of the exposure condition setting table TBL1.

Preferably, it is assumed in the first embodiment that donor sheet rolls of color types larger in number than the donor sheet rolls simultaneously storable in the rotary rack 210 and the exposure condition setting table TBL1 registers this information. According to the first embodiment, as described later, a proof image finished approximately to a regularly output image from a regular printing press can be obtained by properly exchanging the stored donor sheet rolls even if color components larger in number than those simultaneously storable in the rotary rack 210 are employed.

The display operation part 600 is the so-called touch panel displaying the operating situation of the image transferring recorder 1 and enabling the operator to perform a prescribed input operation. The display operation part 600, not shown in FIG. 2, is preferably arranged on the upper or front surface of the body of the image transferring recorder 1. Alternatively, the display operation part 600 may be properly supported by support bodies to be provided on a side portion of the body of the image transferring recorder 1, for example, independently of the body of the image transferring recorder 1. Further alternatively, the display operation part 600 may be replaced with a separately provided personal computer enabling the operator to grasp the operating situation or perform the input operation.

The mechanical components of the image transferring recorder 1 and operations thereof are now successively described.

<Receiver Sheet Supply Part>

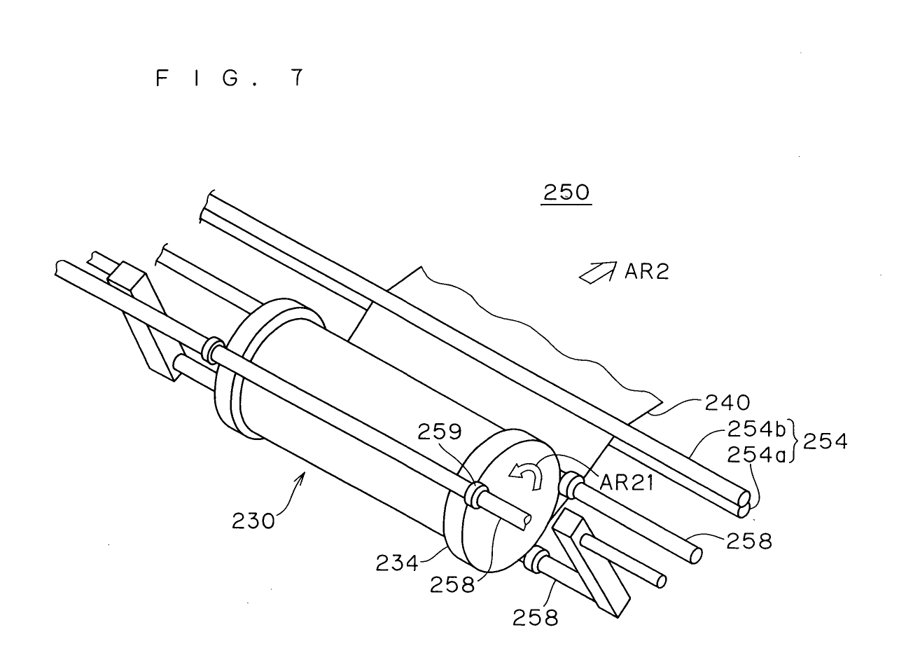

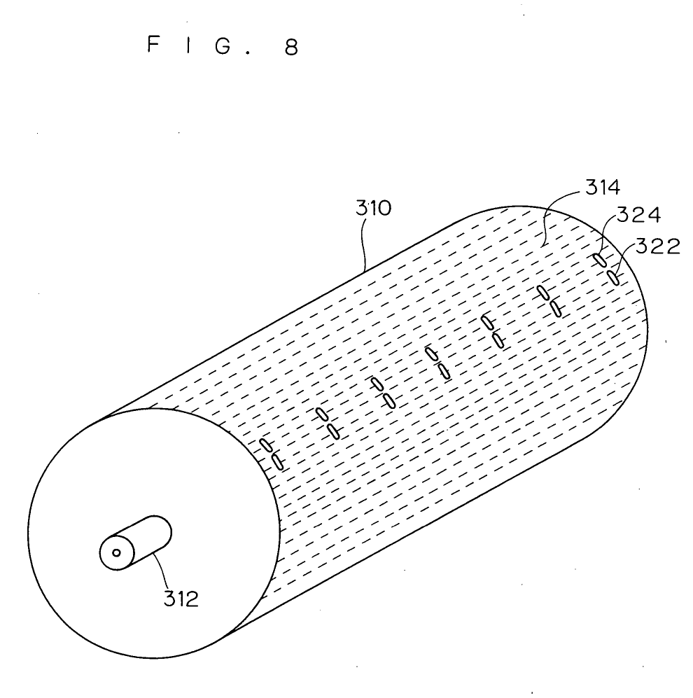

FIG. 6 is a sectional view showing the details of the receiver sheet supply part 100 and the donor sheet supply part 200. FIG. 7 is a perspective view partially showing a donor sheet delivery mechanism 250. The receiver sheet supply part 100 is now described.

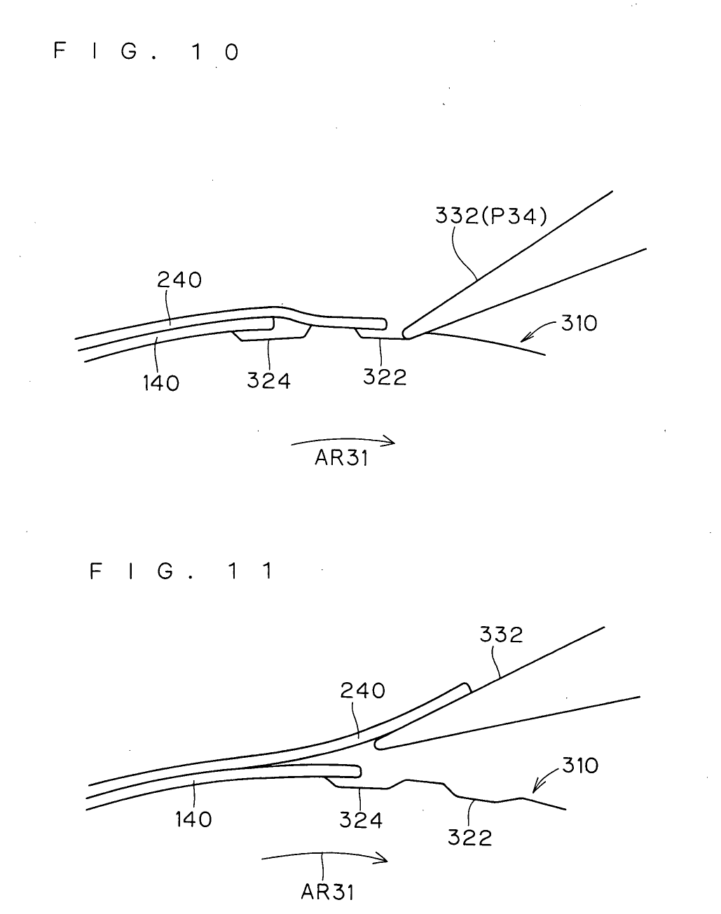

The receiver sheet supply part 100 has a receiver sheet roll 130. A receiver sheet 140 is wound on a core 132 of the receiver sheet roll 130. The receiver sheet 140 has a support layer 142 and a receiver layer 144 stacked on the support layer 142 (see FIG. 9). In the receiver sheet roll 130, the receiver layer 144 is wound on the outer side of the support layer 142 (this receiver sheet roll 130 is hereinafter also referred to as “revolute receiver sheet roll 130”). The receiver sheet roll 130 is set to be rotatable about the central axis of the core 132.

The receiver sheet supply part 100 further has transport rollers 154 and 155, a support guide 156, a receive sheet cutting part 160 and a detection sensor 170 detecting an end point of the receiver sheet 140.

The transport roller 154 has a pair of rollers 154a and 154b, while the transport roller 155 also has a pair of rollers 155a and 155b. Driving means (not shown) drive the rollers 154a and 155a. The rollers 154b and 155b can hold the receiver sheet 140 between the same and the rollers 154a and 155a with prescribed pressure respectively.

The rollers 154b and 155b transport the receiver sheet 140 by rotating oppositely to the rollers 154a and 155b in a follower manner. This driving mechanism can deliver or return the receiver sheet 140 toward or from the image recording part 300.

The receiver sheet supply part 100 having the aforementioned structure supplies the receiver sheet 140 to the image recording part 300.

First, the transport roller 154 holds the forward end of the receiver sheet roll 130 so that the aforementioned driving mechanism including a motor (not shown) draws out the receiver sheet 140 along arrow AR11. Thus, the receiver sheet roll 130 rotates along arrow AR11 to deliver the receiver sheet 140. The transport rollers 155 hold the receiver sheet 140 so that the support guide 156 guides and transports the same.

The receiver sheet cutting part 160 cuts the receiver sheet 140 transported in the aforementioned manner into a prescribed length. The detection sensor 170 is employed for the measurement of the length of the donor sheet 240. The measurement of the length is implemented by detecting the forward end of the receiver sheet 140 with the detection sensor 170 and considering the rotational frequency of the motor or the like. The receiver sheet cutting part 160 cuts the receiver sheet 140 into the prescribed length on the basis of the result of this measurement and supplies the same to the image recording part 300.

<Donor Sheet Supply Part>

Referring again to FIG. 6, the donor sheet supply part 200 is described. The donor sheet supply part 200 has the rotary rack 210. Driving means (not shown) rotates/drives the rotary rack 210 along arrow AR1 about a rotation axis 213. The rotary rack 210 stores a plurality of donor sheet rolls 230, which are “radially” arranged about the rotation axis 213. In other words, the rotary rack 210 functions as donor sheet storage means according to the present invention. A base 201 supporting the rotary rack 210 and the driving means therefor is present under the rotary rack 210 (see FIG. 2).

Each donor sheet roll 230 has a hollow core 232, a donor sheet 240 wound thereon and flanges 234 inserted into both sides of the core 232. As shown in FIG. 7, three bars 258 provided on the rotary rack 210 hold these flanges 234 thereby rotatably holding the donor sheet roll 230. A part of each bar 258 is provided with a sticking out stopper 259 for regulating axial movement of the donor sheet roll 230.

Each donor sheet 240 has a support layer 242 and a color ink layer 244 (see FIG. 9), which are stacked with each other. In the donor sheet roll 230, the color ink layer 244 is wound on the outer side of the support layer 242 (this donor sheet roll 230 is hereinafter also referred to as “revolute donor sheet roll 230”). As described later, the color ink layer 244 has donor inks, which are transferred to the receiver sheet 140 by laser exposure.

Referring to FIG. 6, six donor sheet rolls 230 each having the aforementioned structure are stored one by one in six sections formed in the rotary rack 210. The selection from the six types of donor sheets 240 is performed on the basis of the contents of printing data to be processed, as described later. For example, the rotary rack 210 may store donor sheets 240 of the four process colors of cyan (C), magenta (M), yellow (Y) and black (K) and donor sheets 240 of two special colors such as gold and silver, or may store donor sheets 240 of further specific colors selected in place of the aforementioned donor sheets 240 of the process colors.

The rotary rack 210 further has a plurality of donor sheet delivery mechanisms 250. The donor sheet delivery mechanisms 250 are provided in correspondence to the plurality of donor sheet rolls 230 respectively. Referring to FIG. 6, the rotary rack 210 is provided with six donor sheet delivery mechanisms 250. Each donor sheet delivery mechanism 250 is now described with reference to FIGS. 6 and 7.

Each donor sheet delivery mechanism 250 has a feed roller 254, a support guide 256 and the three bars 258. As hereinabove described, the three bars 258 come into contact with the outer peripheries of the flanges 234 for holding the donor sheet roll 230.

The feed roller 254 has rollers 254a and 254b. The roller 254a, driven by driving means (not shown), can hold the donor sheet 240 between the same and the roller 254b with prescribed pressure. The roller 254b rotates oppositely to the roller 254a, thereby transferring the donor sheet 240. The donor sheet 240 held by the rollers 254a and 254b can be delivered or returned. The donor sheet roll 230 rotates following transfer of the donor sheet 240. The three bars 258 hold the donor sheet roll 230 while relatively rotating with respect to the flanges 234.

The donor sheet delivery mechanism 250 having the aforementioned structure supplies each donor sheet 240 to the image recording part 300. The driving means (not shown) drives the feed roller 254 holding the forward end of the donor sheet roll 230. Thus, the donor sheet roll 230 rotating along arrow AR21 delivers the donor sheet 240 along arrow AR2. A donor sheet transport part 270 cuts the donor sheet 240 into a prescribed length and supplies the same to the image recording part 300.

Each feed roller 254 provided in the rotary rack 210 has a function of temporarily curling the part of the donor sheet 240 just delivered from the donor sheet roll 230 oppositely to a curling direction in the wound state and feeding the same afterward. The feed roller 254 feeds the donor sheet 240 to the donor sheet transport part 270, with its delivered part from the donor sheet roll 230 temporarily oppositely curled in advance. Accordingly, the donor sheet 240 to be fed is remedied a tendency to curl derived from a wound state on the donor sheet roll 230 to some extent, and is never supplied to the donor sheet transport part 270 or the drum 310 in an excessively curled state.

Referring again to FIG. 6, the donor sheet supply part 200 further has the donor sheet transport part 270. The donor sheet transport part 270 has transport rollers 274 and 275, a guide 276, a donor sheet cutting part 280 and a detection sensor 290 detecting an end of each donor sheet 240.

The transport roller 274 has a pair of rollers 274a and 274b, while the transport roller 275 also has a pair of rollers 275a and 275b. Driving means (not shown) drives the rollers 274a and 275a. The rollers 274b and 275b can hold the donor sheet 240 between the same and the rollers 274a and 275a with prescribed pressure respectively.

The rollers 274b and 275b transport the donor sheet 240 by rotating oppositely to the rollers 274a and 275a. This driving mechanism can deliver or return the donor sheet 240 toward or from the image recording part 300.

The donor sheet cutting part 280 cuts the donor sheet 240 transported in the aforementioned manner into a prescribed length. The detection sensor 290 is employed for the measurement of the length of the donor sheet 240. The measurement of the length is implemented by detecting the end of the donor sheet 240 with the detection sensor 290 and considering the rotational frequency of a motor constituting the driving mechanism or the like. The donor sheet cutting part 280 cuts the donor sheet 240 into the prescribed length on the basis of the result of this measurement and supplies the same to the image recording part 300.

<Exchange of Receiver Sheet Roll and Donor Sheet Roll>

The image transferring recorder 1 according to the first embodiment is constituted to allow to detach any donor sheet roll 230 and replace the same with a new donor sheet roll 230 at the time of performing image recording processing or terminating processing as to one color component, in case that printing data subjected to image recording has a large number of color components. When the receiver sheet 140 and the donor sheet 240 are consumed, the used receiver sheet roll 130 and the used donor sheet roll 230 must be detached and be replaced to another receiver sheet roll 130 and another donor sheet roll 230 on which a new receiver sheet 140 and a new donor sheet 240 are wound respectively. This is now described with reference to FIG. 2 again.

First, the exchange of the donor sheet roll 230 comes to be enabled by opening a lid 12 on the image transferring recorder 1 (see FIG. 2). At this time, the image transferring recorder 1 rotates the rotary rack 210 by a prescribed operation thereby moving the donor sheet roll 230 to be exchanged to a prescribed exchange position P12 corresponding to the lid 12.

The image transferring recorder 1 may have to exchange a plurality of donor sheet rolls 230 depending on the number of color components employed for image recording. In this case, it is also allowed to continuously exchange the plurality of donor sheet rolls 230 by rotating the rotary rack 210 and successively moving the donor sheet rolls 230 to the prescribed exchange position P12. When the plurality of donor sheet rolls 230 are exchanged, therefore, the successive exchange of the plurality of donor sheet rolls 230 is enabled on the precisely same exchange position P12 after opening the lid 12.

On the other hand, the exchange of the receiver sheet roll 130 is enabled by opening another lid 11 on the image transferring recorder 1. As the exchange of the receiver sheet roll 130 is performed with excellent workability by ensuring a relatively large space in the vicinity of an opening of the lid 11 and without rotating the rotary rack 210, the receiver sheet roll 130 is exchanged more easily than the donor sheet roll 230. Generally, the exchange of the receiver sheet rolls 130 is performed at timing different from that for exchanging the donor sheet rolls 230. Therefore, the labor remains unchanged despite the lid 11 provided on a position different from that of the lid 12.

<Image Recording Part>

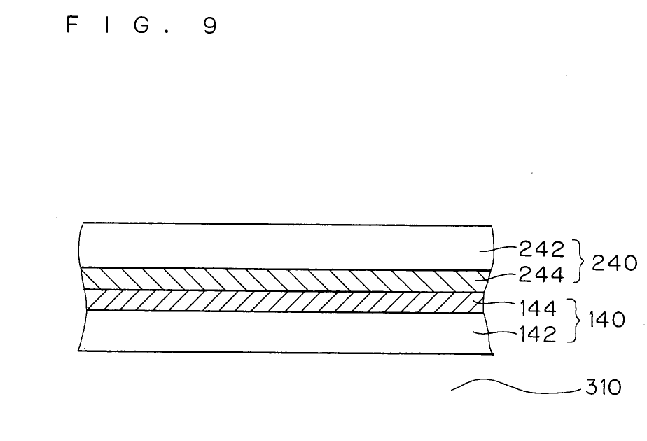

The image recording part 300 has the drum 310 (see FIG. 2). FIG. 8 is a perspective view showing the drum 310. The drum 310, having a hollow cylindrical shape, is rotatably held on a frame (not shown). A driving mechanism (not shown) rotates/drives the drum 310 about an axis 312.

A plurality of holes 314 are formed on the surface of the drum 310. The holes 314 are connected to a blower (not shown) through the hollow portion of the drum 310 etc. When the receiver sheet 140 and the donor sheet 240 are placed on the drum 310 and the blower is operated, the drum 310 absorbs the sheets 140 and 240.

The drum 310 also has a plurality of grooves 322 linearly provided in parallel with the rotation axis of the drum 310. The drum 310 further has another plurality of grooves 324 linearly provided in parallel with the rotation axis of the drum 310, similarly to the plurality of grooves 322. The grooves 324 are located on positions corresponding to those of the grooves 322 respectively in the direction parallel to the rotation axis of the drum 310. Thus, the drum 310 has two lines of grooves 322 and 324, which are employed for peeling the donor sheet 240 and the receiver sheet 140 respectively.

The receiver sheet 140 supplied by the receiver sheet supply part 100 is first wound on the drum 310. The receiver sheet 140 is absorbed by and wound on the drum 310 with the rotation of the drum 310.

Then, a donor sheet 240 supplied from the donor sheet supply part 200 is wound on the receiver sheet 140. The receiver sheet 140 and the donor sheet 240 are different in size from each other. More specifically, the donor sheet 240 is larger than the receiver sheet 140 in both of the vertical and transverse directions. Therefore, the donor sheet 240 is adsorbed by the drum 310 through a part larger than the receiver sheet 140. The donor sheet 240 is adsorbed by and wound on the drum 310 rotating in the same direction as that for fixing the receiver sheet 140.

FIG. 9 is an enlarged view showing the receiver sheet 140 and the donor sheet 240 wound on the drum 310. The receiver sheet 140 has the support layer 142 and the receiver layer 144, while the donor sheet 240 has the support layer 242 and the color ink layer 244. The receiver sheet 140 is supplied from the revolute receiver sheet roll 130 and is wound on the drum 310, with the receiver layer 144 located just on the support layer 142. The donor sheet 240 is supplied from the revolute donor sheet roll 230 and is wound on the receiver sheet 140 and the drum 310, with the color ink layer 244 located just under the support layer 242. Thus, the receiver sheet 140 and the donor sheet 240 are so wound on the drum 310 that the color ink layer 244 of the donor sheet 240 is in contact with the receiver layer 144 of the receiver sheet 140, as shown in FIG. 9. Donor inks of the color ink layer 244 having such positional relation are transferred to the receiver sheet 140 through laser exposure with the recording head 350, as described below.

The image recording part 300 further has the recording head 350 (see FIG. 2). The recording head 350 can emit beam-shaped laser light. Donor inks located on positions of the donor sheet 240 irradiated with the laser beam are transferred to the surface of the receiver sheet 140. The recording head 350 can linearly move in the direction parallel to the rotation axis of the drum 310 through a driving mechanism (not shown). Therefore, combination with rotation of the drum 310 and linear movement of the recording head 350 makes it possible to laser-expose desired positions of the donor sheet 240 covering the receiver sheet 140. In laser exposure, the drum 310 preferably rotates oppositely to the direction for winding the receiver sheet 140 and the donor sheet 240 thereon.

On the image transferring recorder 1, transfer of a desired image to the receiver sheet 140 is implemented by scanning the donor sheet 240 with the laser beam, i.e., an optical beam for drawing, and laser-exposing only corresponding positions on the basis of image information.

<Peeling and Discharge of Sheets>

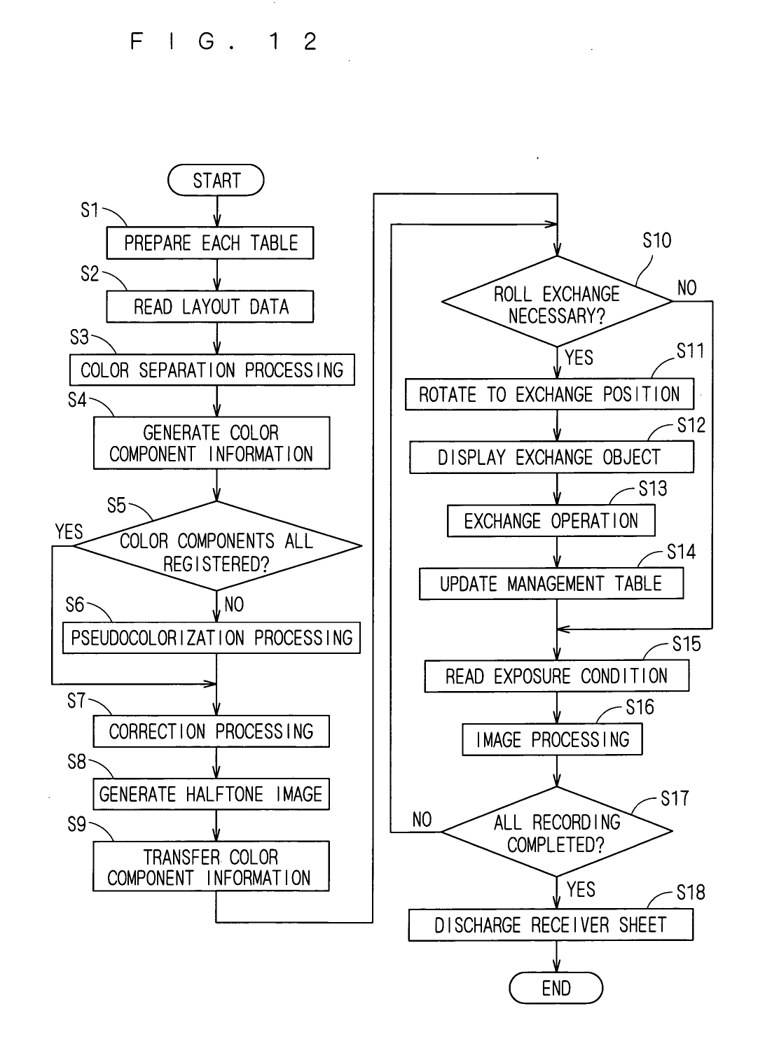

When completing a transfer operation from each donor sheet 240, the image transferring recorder 1 peels the donor sheet 240. FIG. 10 illustrates the forward ends of the receiver sheet 140 and the donor sheet 240 completely wound on the drum 310, and a peeler 332 moved down to a peeling position P34. FIG. 11 shows the forward end of the donor sheet 240 in a state being peeled. A plurality of peelers 332 are linearly provided above the drum 310 in parallel with the rotation axis of the drum 310. The peelers 332 are provided in the same number as the plurality of grooves 322 on positions corresponding to the grooves 322 respectively in the direction parallel to the rotation axis of the drum 310.

In order to peel the donor sheet 240, the drum 310 is rotated at a prescribed peeling speed along arrow AR31. Then, the forward end of each peeler 332 is moved from a prescribed standby position not in contact with the drum 310 to the position P34 coming into contact with the drum 310, while not coming into contact with the donor sheet 240. Following rotation of the drum 310 along arrow AR31, each peeler 332 peripherally relatively moves on the drum 310 along the surface thereof. The forward end of each peeler 332 relatively moves on the surface of the drum 310 following the shape of the corresponding groove 322, then it slides into under side of the donor sheet 240. The donor sheet 240 moves along the upper surface of the peeler 332. Force exceeding the suction force of the blower acts on the donor sheet 240 thereby peeling the donor sheet 240 from the drum 310. The peeler 332 rises in a direction further separating from the drum 310 before coming into contact with the receiver sheet 140 and moves to the standby position. With the drum 310 continuously rotating after the forward end of the donor sheet 240 is peeled, the donor sheet 240 is further peeled from the drum 310 and the receiver sheet 140. At this time, the drum 310 remains adsorbing the receiver sheet 140 due to the suction force of the blower, so that only the donor sheet 240 can be peeled.

The donor sheet 240 peeled through the aforementioned operation is discharged into a donor sheet recovery box 40 comprised outside the image transferring recorder 1 further through the discharge part 400.

In order to continuously perform image recording as to another color component, another donor sheet 240 of another color is wound on the receiver sheet 140 still wound on the drum 310. Similarly to the aforementioned case, donor inks from the donor sheet 240 is transferred to the receiver sheet 140 and thereafter the donor sheet 240 is peeled and discharged.

Image recording and subsequent peeling is similarly repeated until image recording as to all color components is terminated. In case of recording an image as to the four color components of cyan (C), magenta (M), yellow (Y) and black (K), for example, the repetition of the aforementioned operations on the donor sheets 240 of these four types causes transfer of a color halftone image of the process colors to the receiver sheet 140.

When image recording as to all color components is terminated, the receiver sheet 140 to which a plurality of types of donor inks have been transferred is peeled. Similarly to the case of peeling the donor sheet 240, peeling of the receiver sheet 140 is implemented by sliding the peelers 332 into the grooves 324 while rotating the drum 310. The receiver sheet 140 peeled in the aforementioned manner is discharged to a tray 50 provided thereon through the discharge part 400.

The operator carries the receiver sheet 140 discharged on the tray 50 to the aforementioned separately provided laminator 900, which in turn transfers the image of the plurality of colors of donor inks formed on the receiver sheet 140 to a regular paper. Thus, a proof image is transferred to the regular paper.

<Image Recording Processing>

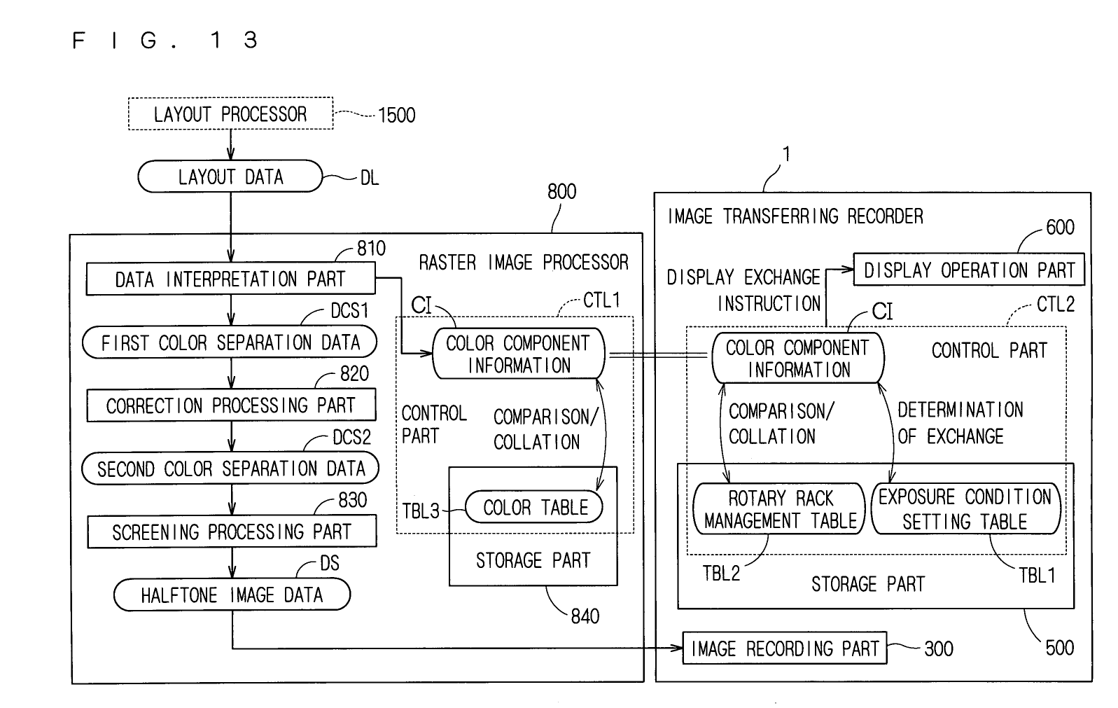

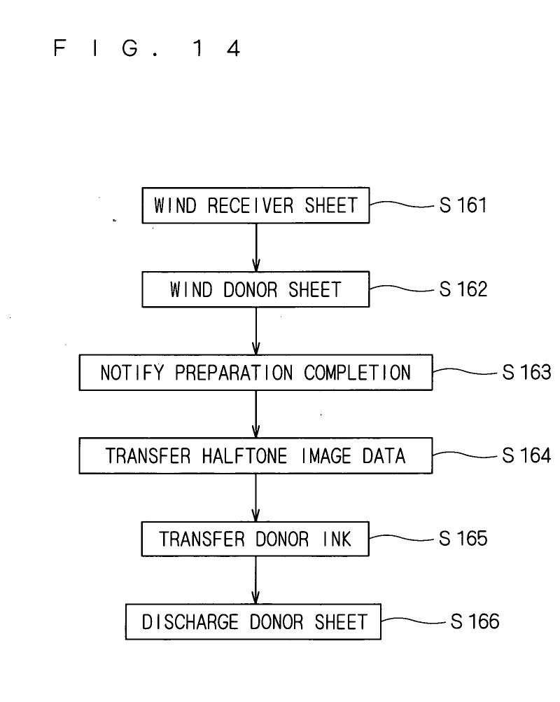

The aforementioned image recording system 1000 can form a desired color image on the receiver sheet 140. FIG. 12 is a flow chart of image recording processing in the image recording system 1000. FIG. 13 illustrates a flow of data related to image recording.

First, it is previously performed to register prescribed contents in each of the tables TBL1 to TBL3 (step S1). The exposure condition setting table TBL1 is intended to register information as to all donor sheet rolls 230 prepared to be used in the image transferring recorder 1. In case of the exposure condition setting table TBL1 shown in FIG. 3, the flags C11, the color codes C12, the roll names C13, the light quantities C14 of the laser beam in exposure and the rotational frequencies C15 of the drum 310 are registered. The rotary rack management table TBL2 is intended to register respective storage positions of the rotary rack 210 and the stored donor sheet rolls 230 in association with each other. Referring to FIGS. 4A to 4C, the section numbers C21 for identifying the storage positions of the donor sheet rolls 230 is associated with the color codes C22. The color table TBL3 is intended to register the flags C11, the color codes C12 and the roll names C13 of the same contents as those described in the exposure condition setting table TBL1.

The data stored in the exposure condition setting table TBL1 are prepared for every donor sheet 240 usable on the image transferring recorder 1. The types of the usable donor sheets 240 not frequently updated, it is not needed to update the registration contents of the exposure condition setting table TBL1 every image recording.

When the tables TBL1 to TBL3 are prepared, the raster image processor 800 reads layout data DL for printing from the layout processor 1500 (step S2). Alternatively, the raster image processor 800 may read layout data DL already stored in the storage part 840. The read layout data DL is inputted in the data interpretation part 810. The data interpretation part 810 interprets the description contents of the layout data DL, and generates first color separation data DCS1 which expresses an image obtained by color-separating a printed image expressed by the layout data DL every ink color used in regular press, on the basis of the described color information. When performing color separation for printing the printed image expressed by the layout data DL with inks of seven colors of cyan (C), magenta (M), yellow (Y), black (K), green (G), white (W) and violet (V), for example, the data interpretation part 810 generates seven first color separation data DCS1 corresponding to the colors respectively.

Along with this generation of the first color separation data DCS1, the data interpretation part 810 generates color component information CI indicating as to what color components the first color separation data DCS1 have been generated (step S4). The color component information CI corresponds to information indicating in what order with which color components images should be formed on the image transferring recorder 1. Information specifying the types of the color components (seven colors in the aforementioned case) and the order for image formation is described as the color component information CI according to a prescribed format with color codes. In this embodiment, it is assumed that the color component information CI is described on the assumption that image-recording of respective color components of color codes (c, m, y, k, s2, s11 and s16) corresponding to the aforementioned seven colors is successively executed from the head-coded color component.

The roll names corresponding to the color codes s2, s11 and s16 are green, white and violet respectively (see FIG. 5). Preferably, the order for image formation with the plurality of color components is decided to be inverse to that for overprinting with inks in regular press. This is because, if the image on the receiver sheet 140 is transferred to the regular paper on the laminator 900 in this case, the proof image is formed on the regular paper, with its ink layers stacked in inverse order to the ink transfer order on the image transferring recorder 1. Thus, the order of forming the ink layers in the proof image is identical to the order of forming ink layers to be implemented in regular press, whereby identifiability of the proof image with respect to an image to be obtained by regular press can be improved.

For example, process color inks are generally superposed on special color inks in regular press. Accordingly, image-recording with the process colors is generally executed in advance of that with the special colors on the image transferring recorder 1. Among the process colors, black is often subjected to print in first in regular press. Therefore, recording in black on the image transferring recorder 1 is performed at the end. Among special colors, on the other hand, white is subjected to print relatively later in regular press. Therefore, recording in white on the image transferring recorder 1 is performed in a relatively early stage.

When the interpretation part 810 generates the color component information CI, the control part CTL1 compares/collates the color component information CI with the color table TBL3. Thus, the control part CTL1 determines whether or not the color components described in the color component information CI are those registered in the color table TBL3 (step S5). Now, all of the aforementioned seven color codes (c, m, y, k, s2, s11 and s16) are registered in the color table TBL3. This means that the exposure condition setting table TBL1 includes registrations of these color codes (c, m, y, k, s2, s11 and s16), whereby it follows that it is determined at the step S5 whether or not the proof image can be formed with such donor sheet 240 as expressing the color components of the inks employed in regular press.

For the present, a case where it is determined that all of the color components described in the color component information CI are registered in the color table TBL3 (YES at the step S5) as a result of comparison/collation is described. In this case, prescribed correction processing is performed (step S7) on the first color separation data DCS1 of the respective color components through the function of the correction processing part 820 and it causes generation of second color separation data DCS2 for the respective color components. In the aforementioned case, for example, the second color separation data DCS2 are obtained as such as to all color components since all of the color components of the seven colors employed in regular press are previously registered on the color table TBL3.

When the second color separation data DCS2 is obtained, halftone image data DS, actually employed for transferring the image in the image transferring recorder 1, is generated through the function of the screening processing part 830 (step S8).

Then, the color component information CI is transferred to the image transferring recorder 1 (step S9). The control part CTL2 of the image transferring recorder 1 compares/collates the received color component information CI with the rotary rack management table TBL2 and determines whether or not the donor sheet roll 230 must be exchanged (step S10). According to the first embodiment, the control part CTL1 of the raster image processor 800 generates the information as to the types of the donor sheets 240 to be employed in the image transferring recorder 1 and after that, supplies the same to the image transferring recorder 1, whereby the operator may neither determine which donor sheet rolls 230 are necessary nor manually input the information as to the employed donor sheets 240 in the image transferring recorder 1. Thus, the operator requires no deep knowledge as to recording of the proof image but automation of operations is prompted.

The rotary rack 210 can store six donor sheet rolls 230 at the maximum, and hence any of the stored donor sheet rolls 230 must be exchanged at least once in order to record the image as to the seven color components indicated in the aforementioned color codes. The image transferring recorder 1 according to the first embodiment is controlled to be capable of exchanging the donor sheet roll 230 in an intermediate stage of image recording processing, when necessary. The procedure of the exchange can be variously set according to the types of the donor sheet rolls 230 stored in the rotary rack 210 or the types of the donor sheet rolls 230 to be employed. In the first embodiment, it is assumed that the control part CTL2 so controls as to preferentially exchange donor sheet rolls 230 not to be used for image recording but stored in the rotary rack 210 for donor sheet rolls 230 not stored in the rotary rack 210 but to be used for image recording. Some representative cases are now described. If the image recording is executable with only the donor sheet rolls 230 stored in the rotary rack 210, no exchange operation takes place but the image recording is executed along the order described in the color component information CI, as a matter of course.

(Case 1) Consider a case, represented in a rotary rack management table TBL2a shown in FIG. 4A, that donor sheet rolls 230 of the process colors are stored in sections 1 to 4 of the rotary rack 210, while donor sheet rolls 230 of green and white are stored in the sections 5 and 6 respectively.

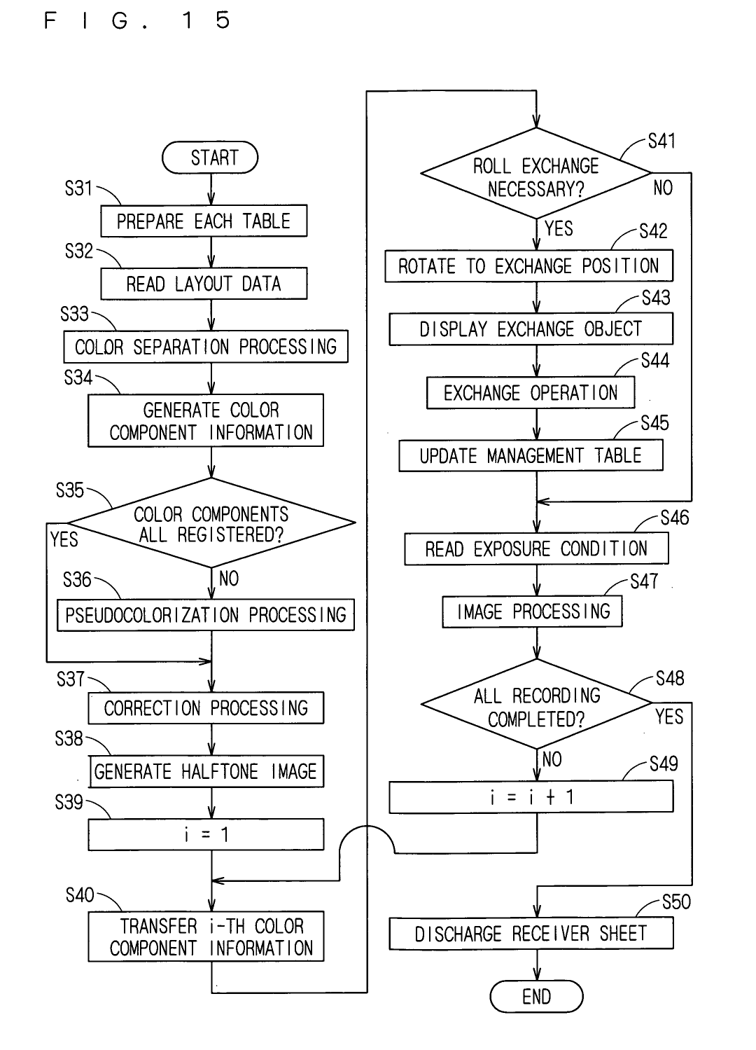

In this case, the color codes indicating all donor sheet rolls 230 stored in the rotary rack 210 match with the color codes described in the color component information CI. In other words, all donor sheet rolls 230 are employed for image formation, whereby the image transfer as to the first color component, i.e., cyan in this case, is performed without exchanging the donor sheet rolls 230 (NO at the step S10). The control part CTL2 reads out the exposure condition, for cyan registering the flag C11 as “1”, associated with the color code c for cyan from the exposure condition setting table TBL1 (step S15), and executes image recording according to this exposure condition (step S16). Thus, the control part CTL2 reads the exposure condition as to the color component to be recorded on the basis of the color code C12 so that the image recording under the optimum condition becomes executable without setting the exposure condition punctatim by the operator according to the color component. The image transferring recorder 1 transfers/records the image as shown in FIG. 14 with reference to cyan.

First, the receiver sheet 140 is provided by delivering and cutting of a part of the revolute receiver sheet roll 130 through the function of the receiver sheet supply part 100, and is wound on the drum 310 (step S161). Then, rotation of the rotary rack 210 through the function of the donor sheet supply part 200 causes the donor sheet roll 230 of cyan to move to a position opposite to the donor sheet transport part 270. The donor sheet 240 is provided by partially delivering and cutting of the revolute donor sheet roll 230, and is wound on the drum 310 (step S162).

After these preparations are completed, the control part CTL2 transmits a preparation complete signal to the control part CTL1 (step S163). In response to this, the control part CTL1 transfers the halftone image data DS as to cyan from the raster image processor 800 to the image transferring recorder 1 (step S164). Keeping on rotating the drum 310, the control part CTL2 makes the recording head 350 emit the laser beam according to setting of the exposure condition for cyan as read out. The control part CTL2 controls emitting on/off of the laser beam according to the received halftone image data DS thereby the image transferred/recorded from the sheet 240 for cyan to/on the receiver sheet 140 (step S165). When the image recording of cyan is completed, the donor sheet 140 of cyan is peeled from the drum 310 and discharged to the donor sheet recovery box 40 through the discharge part 400 (step S166).

When image recording as to the color component of cyan is completed, the control part CTL1 determines whether or not there are data for other color components to be recorded (step S17). In case of the aforementioned example, transfer/recording about the six remaining color components must be executed so image recording is not terminated (NO at the step S17) but shifts to transfer recording of the subsequent color component (magenta). Thus, returning to the step S10, the control part CTL2 determines necessariness/unnecessariness of exchange of the donor sheet roll 230 again.

At this point of time, the donor sheet roll 230 of cyan has been spent while the donor sheet roll 230 of violet to be finally employed for transfer is not yet stored. Therefore, it follows that the control part CTL2 rotates the rotary rack 210 for locating the donor sheet roll 230 of cyan on the exchange position P12 (step S11). In association with this, the control part CTL2 makes the display operation part 600 display a message for requesting the operator to exchange the donor sheet roll 230 of cyan with the donor sheet roll 230 of violet (step S12). When the display operation part 600 displays this message, the operator opens the lid 12 for exchanging the donor sheet roll 230 of cyan located on the exchange position P12 with the donor sheet roll 230 of violet (step S13). After exchanging the donor sheet roll 230, the operator operates the display operation part 600 for updating the description contents of the rotary rack management table TBL2. In other words, the operator writes in the rotary rack management table TBL2 that the section 1 of the rotary rack 210 stores violet (step S14). Thus, the color components of the donor sheet rolls 230 stored in the rotary rack 210 are correctly grasped subsequently, by referring to the rotary rack management table TBL2.

While successively recorded images of magenta, yellow, . . . similarly to the above, all donor sheet rolls 230 employed for image recording are already stored and hence successive image recording as to the respective color components is performed without exchange processing. At this time, the exposure conditions as to the respective color components previously registered in the exposure condition setting table TBL1 is referable, whereby the operator may not set the exposure conditions every image recording as to a new color component.

(Case 2) Consider a case, represented in a rotary rack management table TBL2b shown in FIG. 4B, that the donor sheet rolls 230 of the process colors are stored in the section 1 to 4 of the rotary rack 210 and donor sheet rolls 230 of orange and white are stored in the sections 5 and 6 respectively. In this case, the color code s1 does not match with the color codes described in the color component information CI among the color codes of the donor sheet rolls 230 stored in the rotary rack 210. In other words, the donor sheet roll 230 of orange is unnecessary for image recording to be performed. Therefore, this donor sheet roll 230 is subjected to exchange at first (YES at the step S10). The control part CTL2 determines to first exchange the donor sheet roll 230 of green corresponding to the color code s2, for that color code to be firstly subjected to image recording in the color codes s2 and s16 which are both described in the color component information CI but undescribed in the rotary rack management table TBL2. Consequently, the control part CTL2 rotates the rotary rack 210 for locating the donor sheet roll 230 of orange on the exchange position P12 (step S11) and requests the display operation part 600 to display that the operator must exchange the donor sheet roll 230 located on the exchange position with the donor sheet roll 230 of green (step S12). When the operator terminates this exchange operation and an update operation for the rotary rack management table TBL2 (steps S13 and S14), image recording about the first color component, i.e., cyan is performed similarly to the case 1 (steps S15 and S16).

After completion of image recording of cyan, the donor sheet roll 230 of cyan is exchanged with the donor sheet roll 230 of violet and subsequent image recording is continued.

(Case 3) Consider a case, represented in a rotary rack management table TBL2c shown in FIG. 4C, that the donor sheet rolls 230 of the process colors are stored in the sections 1 to 4 of the rotary rack 210 and donor sheet rolls 230 of orange and silver are stored in the sections 5 and 6 respectively. In this case, the color codes s1 and s7 do not match with the color codes described in the color component information CI among the color codes of the donor sheet rolls 230 stored in the rotary rack 210. In other words, the donor sheet rolls 230 of orange and silver are unnecessary for image recording to be performed. Therefore, these donor sheet rolls 230 must be exchanged (YES at the step S10).

In this case, the control part CTL2 determines to first exchange the donor sheet roll 230 of green corresponding to the color code s2 with the donor sheet roll 230 of orange or silver, for that color code to be firstly subjected to image recording among the color codes s2, s11 and s16 which are all described in the color component information CI but undescribed in the rotary rack management table TBL2, similarly to the case 2. When there are a plurality of donor sheet rolls 230 to be exchanged, for example, it is assumed that the control part CTL2 makes control to preferentially exchange the donor sheet rolls 230 stored in the section having the minor section number. In this case, the donor sheet 230 of orange (stored in the section No. 5) is given preference over that of silver (stored in the section No. 6). Therefore, the control part CTL2 determines to exchange the donor sheet roll 230 of orange with the donor sheet roll 230 of green. When the operator completes to exchange the donor sheet roll 230 of orange arranged on the exchange position P12, the control part CTL2 rotates the rotary rack 210 thereby moving the donor sheet roll 230 of silver to the exchange position P12. Then, the control part CTL2 makes the display operation part 600 display a message for requesting the operator to exchange the donor sheet roll 230 located on the exchange position P12 with the donor sheet roll 230 of white, thereby prompting the operator to exchange the donor sheet roll 230. When the donor sheet roll 230 of white is stored in the rotary rack 210, image recording about cyan, storing the donor sheet roll 230 of violet, and image recording about magenta are successively performed thereafter and the remaining colors similarly to the case 1.

In each of the cases 1 to 3, image recording process terminates when completing image recording as to violet (YES at the step S17). The receiver sheet 140 is peeled from the drum 310 and discharged to the tray 50 through the discharge part 400 (step S18). The obtained receiver sheet 140 is supplied to the laminator 900, which in turn transfers the recorded image to a printing paper.

According to the first embodiment, it is the control part CTL2 in each of the aforementioned cases 1 to 3 that determines which ones of the donor sheet rolls 230 stored in the rotary rack 210 are to be exchanged, whereby the operator may not make this determination but may simply exchange the donor sheet roll 230 located on the exchange position P12 with the donor sheet roll 230 displayed on the display operation part 600 and input information indicating which donor sheet roll 230 has been stored. Further, the operator may not set the exposure condition in image recording as to each color component either. Therefore, the operator can perform operations without special knowledge about color separation and image recording.

While the control part CTL2 of the image transferring recorder 1 decides the donor sheet roll 230 to be detached from the rotary rack 210 for exchange in the above description, the operator may alternatively decide this donor sheet roll 230. In this case, the operator can decide the donor sheet roll 230 to be detached from the rotary rack 210 through his/her manual operation in consideration of the workflow.

Case of Performing Pseudocolorization

In case that inks employed for regular press are specific ones or no donor sheet rolls 230 capable of reproducing colors expressed by these inks are prepared, the color table TBL3 as well as the exposure condition setting table TBL1 have no registration about the color components corresponding to the color codes described in the color component information CI at the step S5 (NO at the step S5). In this case, it is impossible to perform image recording as to the unregistered color components though color separation is executed in the data interpretation part 810, so it is required to perform pseudocolorization processing of reproducing the unregistered color components substitutionally with registered color components (step S6).

For example, consider the case that color separation for regular press is set up for printing with inks of seven colors of cyan (C), magenta (M), yellow (Y), black (K), red (R), white (W) and violet (V) but no donor sheet roll 230 of red is prepared and no registration about it exists in the exposure condition setting table TBL1 and the color table TBL3. In this case, the data interpretation part 810 creates first color separation data DCS1 expressing respective color component images of cyan (C), magenta (M), yellow (Y), black (K), red (R), white (W) and violet (V) from the layout data DL (step S3) and creates color component information CI indicating that these color components are included (step S4). The control part CTL1 compares this color component information CI with the storage contents of the color table TBL3. Since the exposure condition setting table TBL1 and the color table TBL3 have no registration about the donor sheet roll 230 of red, the control part CTL1 determines that pseudocolorization must be performed as to red and requests the correction processing part 820 to perform pseudocolorization as to the color component of red in advance of correction processing such as color matching of the first color separation data DCS1. The correction processing part 820 makes color separation of the first color separation data DCS1 as to the red component into color separation data of the remaining six color components employed for printing. The correction processing part 820 further superposes six color component image data obtained by this color separation on the remaining six first color separation data DCS1 for generating pseudocolorized first color separation data DCS1. Then, the correction processing part 820 performs correction processing such as color matching on the six pseudocolorized first color separation data DCS1. The six pseudocolorized first color separation data DCS1 subjected to correction processing such as color matching are outputted to the screening processing part 830 as second color separation data DCS2.

The color component information CI to be transferred to the image transferring recorder 1 is corrected from information indicating color components of seven colors to information indicating respective color components of the six colors (C, M, Y, K, W and V) other than red (R) in response to the results of the aforementioned pseudocolorization processing. Subsequent processing is performed similarly to the above.

According to the first embodiment, the control part CTL1 determines necessariness/unnecessariness of pseudocolorization. If the control part CTL1 determines that pseudocolorization must be performed, the correction processing part 820 subsequently performs it in effect and hence the operator may neither determine necessariness/unnecessariness of pseudocolorization nor specify the color for pseudocolorization. Thus, he/she can perform operations without detailed knowledge about color separation and image recording.

In the case of the first embodiment, however, the donor sheet rolls 230 can be exchanged at need as hereinabove described, and hence it is interpretable that the potentiality of requiring pseudocolorization itself is reduced as compared with prior art so far as the donor sheet rolls 230 are previously sufficiently prepared and the exposure conditions therefor etc. are registered.

In the image recording system 100 according to the first embodiment, as hereinabove described, the donor sheet rolls 230 stored in the rotary rack 210 can be exchanged at need, whereby the upper limit of the number of color components formable on a single receiver sheet 140 is not limited to the number of the donor sheet rolls 230 simultaneously storable in the rotary rack 210. Therefore, a proof image finished in fidelity to image recording in regular press can be obtained so far as donor sheet rolls 230 corresponding to inks employed in regular press are prepared. Further, image recording as to a large number of color components is enabled without increasing the number of the donor sheet rolls 230 storable in the rotary rack 210, whereby transfer processing is allowed as to a larger number of color components without increasing the size of the image transferring recorder 1.

In addition, it is automatically determined which donor sheet rolls 230 are to be exchanged in such exchange, whereby the operator may not previously grasp which donor sheet rolls 230 must be exchanged among the donor sheet rolls 230 stored in the rotary rack 210. The operator can perform operations without advanced knowledge or skill since he/she may simply exchange the donor sheet roll 230 assumed to be the object of exchange with a specified donor sheet roll 230. Further, the exposure condition setting table TBL1 previously has registration about the exposure conditions as to the respective donor sheet rolls 230, whereby the operator may not set the exposure conditions punctatim following exchange.

Further, necessariness/unnecessariness of pseudocolorization and specification of the objective color component on it are automatically determined, whereby the operator may be required neither determination nor deep knowledge and skill as to this processing either.

### Second Embodiment

In the aforementioned first embodiment, the control part CTL1 of the raster image processor 800 transfers the color component information CI to the control part CTL2 of the image transferring recorder 1 thereby simultaneously supplying information as to all color components to the control part CTL2. Alternatively, the control part CTL1 may supply color component information to the control part CTL2 punctatim in the order that images are to be recorded in the image transferring recorder 1. FIG. 15 illustrates a procedure of this case in a second embodiment of the present invention. Referring to FIG. 15, processing in steps S31 to S38 is identical to that in the steps S1 to S8 shown in FIG. 12, and hence redundant description is omitted.

Following a step S39, processing is sequentially performed as to an i-thly image-recorded color component. In a case of recording images as to seven colors of cyan (C), magenta (M), yellow (Y), black (K), green (G), white (W) and violet (V) in this order, for example, a color code (c) for a color component of i=1, i.e., cyan, is transferred to an image transferring recorder 1 as color component information (steps S40 and S41). On the image transferring recorder 1, it is determined whether a rotary rack management table TBL2 has a registration of the color code (c) as to the transferred color component or not, i.e., whether a rotary rack 210 stores a donor sheet roll 230 of cyan at this point of time or not (step S41). Since no roll exchange is necessary if the rotary rack 210 stores the donor sheet roll 230 of cyan (NO at the step S41), image recording is performed (steps S46 and S47). The processing for image recording at the steps S46 and S47 is identical to that in the first embodiment, and hence redundant description is omitted. If the rotary rack 210 stores no donor sheet roll 230 of cyan (YES at the step S41), on the other hand, any donor sheet roll 23 already stored in the rotary rack 210 is moved to an exchange position P12 and an instruction for exchanging the same to the donor sheet roll 230 of cyan is displayed on a display operation part 600 (steps S42 and S43). At this time, the donor sheet roll 230 to be exchanged is arbitrarily set, a mode of preferentially setting not a frequently used donor sheet roll 230 of a process color but a donor sheet roll 230 of a special color as the object of exchange or the like is considerable. When such exchange is completed, image recording is performed similarly to the above (steps S46 and S47).

When the image recording as to the certain i-th color component is completed, a signal of this purport is supplied to the control part CTL1, which in turn determines whether or not recording as to another color component must be performed (step S49). For example, image recording as to magenta must be performed after terminating image recording as to cyan in the above case, whereby, returning to the step S40, color component information as to magenta is transferred as that of the second color component. Thereafter processing as to all color components is similarly repeated, whereby it follows that a proof image is formed on a receiver sheet 140. When all recording is terminated (YES at a step S48), the receiver sheet 140 is discharged to a tray 50 (step S50).

Also in the second embodiment, any donor sheet roll 230 stored in the rotary rack 210 is enabled to exchange at need, whereby the upper limit of the number of color components formable on a single receiver sheet 140 is not limited to the number of the donor sheet rolls 230 simultaneously storable in the rotary rack 210. Therefore, a proof image finished in fidelity to image recording in regular press can be obtained so far as donor sheet rolls 230 corresponding to inks employed in regular press are prepared. Further, image recording as to a large number of color components is enabled without increasing the number of the donor sheet rolls 230 storable in the rotary rack 210, whereby transfer processing is allowed as to a larger number of color components without increasing the size of the image transferring recorder 1.

In addition, necessariness/unnecessariness for exchange of each donor sheet roll 230 is automatically determined in such exchange, whereby the operator may not previously grasp which donor sheet roll 230 is to be exchanged from among the donor sheet rolls 230 stored in the rotary rack 210. Thus, the operator can perform operations without advanced knowledge or skill since he/she may simply exchange the donor sheet roll 230 assumed to be the object of exchange with a specified donor sheet roll 230. Further, the exposure condition setting table TBL1 previously has registration about the exposure conditions as to the respective donor sheet rolls 230, whereby the operator may not set the exposure conditions punctatim following exchange. Alternatively, the operator him/herself may specify the donor sheet roll 230 to be exchanged.

<Modifications>

While the raster image processor 800 holds the color table TBL3 so that the control part CTL1 refers to the same in the aforementioned embodiment, the control part CTL1 may alternatively directly refer to the exposure condition setting table TBL1. In this case, the raster image processor 800 may not hold the color table TBL3.

While a donor sheet roll 230 stored in the rotary rack 210 unnecessary for image recording is preferably exchanged in the first embodiment, it may be alternatively exchanged after performing image recording performable with already stored donor sheet rolls 230 for performing subsequent image recording.

While the control part CTL2 of the image transferring recorder 1 obtains the color component information CI from the raster image processor 800 for performing image recording as to each color component, with necessariness/unnecessariness of roll exchange determined in the first embodiment, the control part CTL1 of the raster image processor 800 may alternatively receive the description contents of the rotary rack management table TBL2 from the image transferring recorder 1 for comparing/collating the color component information CI with the description contents and supplying information as to necessariness/unnecessariness of roll exchange to the image transferring recorder 1 on the basis the results of this comparison/collation.

While pseudocolorization is implemented by performing color separation with the remaining color components employed for regular press in the aforementioned embodiments, pseudocolorization may alternatively be performed with a color component not used in regular press but registered in the exposure condition setting table TBL1, i.e., with remaining color components for which a donor sheet roll 230 are prepared. In this case, reproducibility for a halftone shape in a proof image as to the color component employed in regular press is more improved than the case of performing pseudocolorization in the aforementioned embodiment by not employing the color component employed for regular press for pseudocolorization.

While the invention has been shown and described in detail, the foregoing description is in all aspects illustrative and not restrictive. It is therefore understood that numerous modifications and variations can be devised without departing from the scope of the invention.

1. An image recording system comprising:
a) a printing data processor comprising:
a-1) a color separation data generation element generating a plurality of color separation data by separating printing layout data into a plurality of color components,
a-2) a screening element performing screening processing of generating a plurality of halftone image data outputtable in a prescribed output unit in correspondence to said plurality of color components on the basis of said plurality of color separation data,
a-3) a first control element controlling operations of said printing data processor, and
a-4) a color component information generation element generating color component information indicating said color components on which said color separation data is generated; and
b) an image recorder comprising:
b-1) a transfer film storage element storing a plurality of transfer films corresponding to said plurality of color components,
b-2) an image recording element performing multicolor image recording processing of successively transferring inks from each of objective transfer films to a receiver sheet by applying an optical beam to superposed objective transfer film on said receiver sheet thereby superpositively visualizing said plurality of halftone image data on said receiver sheet with different said color components, wherein said each of objective transfer films is corresponding to each of said plurality of halftone image data among said plurality of transfer films,
b-3) a second control element controlling operations of said image recorder,
b-4) a first reference information registration element registering first reference information indicating the types of transfer films usable in said image recorder, and
b-5) a second reference information registration element registering second reference information indicating the types of said plurality of transfer films stored in said transfer film storage element, wherein
either said first control element or said second control element performs comparison processing of comparing description contents of said color component information with at least single registration contents of said first reference information and said second reference information for setting processing necessary for said multicolor image recording processing on the basis of a result of said comparison processing.

2. The image recording system according to claim 1, wherein
said image recorder further comprises:
b-6) a display element making display for requesting a prescribed operation to an operator, wherein
said image recorder is controlled to be capable of exchanging said transfer films stored in said transfer film storage element with other transfer films not stored in said transfer film storage element in an intermediate stage of said multicolor image recording processing, and
said display element displays a prescribed exchange instruction if said plurality of transfer films in said transfer film storage element are inconsistent with a set of transfer films necessary for said multicolor image recording processing as a result of said comparison processing.

3. The image recording system according to claim 2, arranging one transfer film specified from among said plurality of transfer films on the basis of said result of said comparison processing on a prescribed exchange position as a transfer film to be exchanged when performing exchange based on said exchange instruction, wherein
said exchange instruction includes display specifying the color component of a transfer film to be newly stored and a request for exchanging said transfer film to be newly stored with said transfer film to be exchanged arranged on said exchange position.

4. The image recording system according to claim 2, wherein
said first reference information further includes conditional information specific to each of said plurality of transfer films at the time of performing said multicolor image recording processing, and
said image recording element performs said multicolor image recording processing according to said specific conditional information.

5. The image recording system according to claim 1, wherein
said printing data processor further comprises:
a-5) a pseudocolorization element performing pseudocolorization processing of replacing said color separation data as to arbitrary said color component included in said plurality of color separation data with color separation data as to another color component, wherein said another color component is at least one color component corresponding to any said transfer film already registered in said first reference information among said plurality of transfer films,
said pseudocolorization processing is performed on color separation data as to a color component determined as a transfer film of a type unregistered in said first reference information as said result of said comparison processing in said first control element, and
said screening element performs said screening processing on color separation data present after said pseudocolorization.

6. The image recording system according to claim 1, wherein
said printing data processor further comprises:
a-6) a third reference information registration element registering third reference information having contents substantially identical to registration contents of said first reference information, and
said first control element performs said comparison processing with said third reference information.

7. An image recorder comprising:
a transfer film storage element storing a plurality of transfer films corresponding to a plurality of color components respectively;
an image recording element performing multicolor image recording processing of successively transferring inks from each of objective transfer films to a receiver sheet by applying an optical beam to superposed objective transfer film on said receiver sheet thereby superpositively visualizing a plurality of halftone image data on said receiver sheet with different said color components, wherein said each of objective transfer films is corresponding to each of a plurality of halftone image data among said plurality of transfer films,
a control element controlling operations of said image recorder;
a first reference information registration element registering first reference information indicating the types of transfer films usable in said image recorder; and
a second reference information registration element registering second reference information indicating the types of said plurality of transfer films stored in said transfer film storage element, wherein
said plurality of halftone image data are generated in correspondence to said plurality of color components on the basis of color separation data prepared by color-separating printing layout data into said plurality of color components and outputtable in a prescribed output unit, and
said control element performs comparison processing of comparing description contents of said color component information with at least single registration contents of said first reference information and said second reference information for setting processing necessary for said multicolor image recording processing on the basis of a result of said comparison processing.

8. The image recorder according to claim 7, further comprising a display element making display for requesting a prescribed operation to an operator, wherein
said image recorder is controlled to be capable of exchanging said transfer films stored in said transfer film storage element with other transfer films not stored in said transfer film storage element in an intermediate stage of said multicolor image recording processing, and
said display element displays a prescribed exchange instruction if said plurality of transfer films in said transfer film storage element are inconsistent with a set of transfer films necessary for said multicolor image recording processing as a result of said comparison processing.

9. The image recorder according to claim 8, arranging one transfer film specified from among said plurality of transfer films on the basis of said result of said comparison processing on a prescribed exchange position as a transfer film to be exchanged when performing exchange based on said exchange instruction, wherein
said exchange instruction includes display specifying the color component of a transfer film to be newly stored and a request for exchanging said transfer film to be newly stored with said transfer film to be exchanged arranged on said exchange position.

10. The image recorder according to claim 8, wherein
said first reference information further includes conditional information specific to each of said plurality of transfer films at the time of performing said multicolor image recording processing, and
said image recording element performs said multicolor image recording processing according to said specific conditional information.

11. A printing data processor comprising:
a color separation data generation element generating a plurality of color separation data by separating printing layout data into a plurality of color components;
a screening element performing screening processing of generating a plurality of halftone image data outputtable in a prescribed output unit in correspondence to said plurality of color components on the basis of said plurality of color separation data;
a control element controlling operations of said printing data processor;
a color component information generation element generating color component information indicating said color components on which said color separation data is generated; and
a reference information registration element registering reference information indicating the types of transfer films usable in a prescribed image recorder performing image recording processing with said plurality of halftone image data, wherein
said control element performs comparison processing of comparing description contents of said color component information with said reference information for setting processing necessary for said image recording processing in said image recorder on the basis of a result of said comparison processing.

12. The printing data processor according to claim 11, further comprising a pseudocolorization element performing pseudocolorization processing of replacing said color separation data as to arbitrary said color component included in said plurality of color separation data with color separation data as to another said color component, wherein said another color component is at least one color component corresponding to at least one said transfer film whose information is already registered in said reference information registration element, wherein
said pseudocolorization processing is performed on color separation data as to a color component determined as a transfer film of a type unregistered in said reference information as said result of said comparison processing in said control element, and
said screening element performs said screening processing on color separation data present after said pseudocolorization.

13. A printing data processor comprising:
a) a color separation data generation element generating a plurality of color separation data by separating printing layout data into a plurality of color components;
b) a screening element performing screening processing of generating a plurality of halftone image data outputtable in a prescribed output unit in correspondence to said plurality of color components on the basis of said plurality of color separation data;
c) a first control element controlling operations of said printing data processor; and
d) a color component information generation element generating color component information indicating said color components on which said color separation data is generated, wherein
said printing data processor is used in connection with an image recorder comprising:
1) a transfer film storage element storing a plurality of transfer films corresponding to said plurality of color components,
2) an image recording element performing multicolor image recording processing of successively transferring inks from each of objective transfer films to a receiver sheet by applying an optical beam to superposed objective transfer film on said receiver sheet thereby superpositively visualizing a plurality of halftone image data on said receiver sheet with different said color components, wherein said each of objective transfer films is corresponding to each of said plurality of halftone image data among said plurality of transfer films,
3) a second control element controlling operations of said image recorder, and
4) a reference information registration element registering reference information for identifying the types of said plurality of transfer films stored in said transfer film storage element, and
said first control element compares said color component information with said reference information for requesting an operator to make said plurality of transfer films stored in said transfer film storage element consistent with a set of transfer films necessary for said multicolor image recording processing if the former are inconsistent with the latter while letting said image recording element execute said multicolor image recording processing if the former are consistent with the latter.
